(19) United States
(12) Patent Application Publication
(10) Pub. No.: US 2014/0173522 A1
(43) Pub. Date: Jun. 19, 2014

(54) Novel Character Specification System and Method that Uses Remote Selection Menu and Touch Screen Movements

(71) Applicant: Michael William Murphy, Bellingham, WA (US)

(72) Inventor: Michael William Murphy, Bellingham, WA (US)

(21) Appl. No.: 13/716,228

(22) Filed: Dec. 17, 2012

(51) Int. Cl. G06F 3/0481

(52) U.S. Cl. CPC G06F 3/0481
USPC 715/840

(57) ABSTRACT

A method and apparatus of identifying and selecting characters from among a plurality of characters. In accordance with one embodiment of the invention, a computer processor electronically enables display of primary and secondary characters within a first region on a touch-sensitive electronic screen. Each secondary character has an associated primary character. Selection buttons within a second region on the screen are arranged to correspond with the positions of the primary characters. The computer processor electronically enables selection of a primary character by receiving input resulting from contact of the selection button that corresponds to the selected primary character. Selection of a secondary character is enabled by receiving input resulting from contact of the selection button that corresponds to the selected secondary character's associated primary character and movement of a tool along the screen in the direction of the selected secondary character relative to the selected secondary character's associated primary character.

### BACKGROUND

1. Technical Field

This description generally relates to the field of electronic devices and, more particularly, to user interfaces of electronic devices.

2. Description of the Related Art

Electronic devices often require entry of data in the form of words, sentences, letters, numbers, characters and symbols by a user in order to perform their designed functions. A typical character entry interface that meets this requirement provides a plurality of buttons, each sized to be easily pressed by a human fingertip, with one character assigned to each button and one button for each character that a user could want to select. In English-language cultures, the QWERTY keyboard is one such standard interface and this interface is commonly found on typewriters and computers.

Some electronic devices, either by design or due to a constraint, do not use the standard interface. Portable electronic devices are an example of an entire category of electronic devices that do not typically provide a standard character entry interface. Users of portable devices typically demand that the device fit easily in a pocket or purse. To meet this requirement, portable devices cannot at the same time offer finger-sized keys and enough keys for all the letters of an alphabet. As many portable devices have functions that require character entry, this leads to a conflict between providing a user interface that offers complete and convenient functionality but in a size that can still be carried inside a user's pocket. Many alternative methods for solving this conflict exist in the prior art, as will be discussed below.

In FIG. 1 a cellular phone is shown having a character entry interface and method known in the prior art. The interface includes twelve physical buttons in a 3×4 matrix on a front face of the phone. Ten of the twelve buttons are assigned a numeral, one numeral per button. Eight buttons are also assigned text characters, three characters per button. Both the numerical and text character assignments are indicated on the face of the button. Characters are selected by first choosing a mode—numeral or text character—that identifies which category of character becomes entered by pressing the button. Within text mode, the particular character entered of the three displayed on a given button face is differentiated by the number of times the button is pressed during a given period.

For example, in FIG. 1 the button in the top row middle column of the interface is assigned the numeral 2 and the text characters a, b, and c. According to the method, while in text mode a user presses the button one time to indicate the character a for selection. To indicate character b for selection, the user presses the button two consecutive times. Similarly, the user presses the button three consecutive times to indicate character c for selection. Sequences of characters that can form words and sentences are indicated by consecutively pressing the appropriate physical button the appropriate number of button presses for each subsequent character in the desired word or sentence. This interface and method are well-known in the art and has the advantage of being compact in size; however, the method has the disadvantage of being slow compared with a standard interface due to the number of button presses required to enter many of the text characters.

In FIG. 2 a character entry interface and method similar to the one shown in FIG. 1 is shown. The method is essentially identical to the one shown in FIG. 1. The interface is different in that the buttons are soft keys, meaning that the buttons are graphically represented on changeable display, rather than physical buttons. An advantage of this interface is that it is configurable, because the graphical representation of the keys can be changed on the display. Therefore, the assignment of characters to buttons, the arrangement of the keys, and the overall size of the interface are variable. The method, however, still has the disadvantage of being slow compared with a standard interface due to the number of button presses needed to enter many of the text characters.

In FIG. 3 another user interface and text entry method known in the art is shown. This interface has thirty keys distributed among three rows, ten keys per row. This interface provides enough buttons that every character of a typical alphabet has its own key. Numeric characters still share keys with a text character, therefore a selection between numeric and text mode is still required. The method of indicating characters for selection is straightforward in that a character is indicated by simply pressing the button that displays the desired character on the button face. This method offers the advantage of faster text entry speeds because multiple character presses are not needed to select any of the characters. A disadvantage of the interface is that to meet size constraints the buttons are small relative to a typical user's fingertip. This leads to slower and less accurate character entry compared with a standard interface.

In FIG. 4 a character entry interface and method similar to the one shown in FIG. 3 is shown. The method is essentially identical to the one shown in FIG. 3. The interface is different in that the buttons are soft keys, rather than physical buttons. Like the interface of FIG. 3, this interface provides enough buttons that every character of a typical alphabet has its own key. Characters are indicated for selection by simply pressing the soft key that displays the desired character. An advantage of this interface over the one of FIG. 3 is that panels of various keys can be exchanged, for example the displayed panel of text characters can be exchanged for a panel of numeric characters. While this interface offers improved configurability over the interface of FIG. 3, the disadvantages of that interface, such as the small buttons relative to the size of a user's fingertips, still exist. A further disadvantage of this interface, and one shared with the interface of FIG. 2, is that soft keys provide no tactile feel to the user. A user cannot tactilely distinguish if their finger is on a key or between keys, therefore this interface requires that a user either visually align their finger with the desired button or verify that the desired character was selected by visually checking a display.

In FIG. 5 a variation on the interface of FIG. 4 is shown. The method of FIG. 5 is essentially identical to the ones shown in FIGS. 3 and 4, however the interface rearranges the buttons, and the assignments of the text characters to the buttons, so that the most frequently used characters of a language are assigned next to one another and close to the center of the interface. For example, the commonly used characters of a, e, s, t, r, and o are assigned to buttons at the center of the interface. On the other hand, the less frequently characters of z, k, x, and q are placed at the corners. This arrangement speeds up character entry by minimizing the time required for a user to move fingers between keys because the most frequently used keys are located close to one another. This improvement highlights one disadvantage that all the character entry interfaces share in common—one or two-finger character entry compared with eight-finger entry on a standard QWERTY interface.

In FIG. 6 yet another character entry interface and method known in the art is shown. This interface uses a stylus and a touch-sensitive display screen. A user traces out shapes or symbols that represent characters directly on the display screen. The electronic device is equipped to interpret and recognize the shapes and associate each unique shape with a different text or numerical character. Shapes traced out on the display screen are interpreted as separate characters based on when the stylus is lifted off on and then placed back on the display screen. Typically the user may trace character shapes out anywhere on the display screen and as long as the electronic device is in a mode to receive and interpret these shapes, the shape will be interpreted and the indicated character understood. As an example, a user may have a note-taking application opened and shown on the display of their electronic device. A user places the tip of the stylus on the display and, if they desire to enter the character a, traces a first line segment diagonally upward and to the right on the display screen, followed by a second line segment straight downward on the screen from the end of the first line segment. Once the user picks the stylus up off the screen, the device seeks to interpret the shape, associate it with a particular character, and if recognizable, enter the indicated character a in the note-taking application. A character is interpreted for each continuous stroke of the stylus along the display screen. This interface has an advantage in that no display of a selection character or buttons is required at all, however the method has the disadvantages of requiring the user to trace out characters rather than pressing buttons and to learn the shapes that associated with each character.

In FIG. 7 still another character entry interface and method known in the art is shown. This interface includes a two-stage display, a first stage that displays all the characters available for selection and a second stage that displays a portion of the first stage in a zoom-in view. In the first stage, the available characters are displayed in a single row. A frame lies over the displayed characters and surrounds a portion of the characters. Whatever characters are within the frame are displayed in the second stage, except of a size much larger than displayed in the first frame. The frame is moveable along the row of characters and as characters enter or leave the frame by its movement, the characters shown in the second stage also correspondingly change. The second frame also includes selection buttons on which the characters in the frame are shown. A user indicates a character for selection by pressing the selection button displaying the desired character. If the desired character is not displayed, the user slides the frame in the first stage to cause the desired character to be shown in the second frame, and then presses the appropriate button to indicate the character for selection. An advantage of the interface is that the selection buttons can be made large because there are selection buttons for only a few characters at any one time. The large buttons make the method highly accurate, but a disadvantage is that two different operations must be conducted per character indicated: first moving the frame along the row of characters to display the desired character, and second actually pressing the button displaying the desired character. The two steps make the speed of the method slow compared with any of the others.

In FIG. 8 still another character entry interface and method known in the art is shown. This interface is a keypad that includes an array of soft keys, with each key being assigned to at least one letter of an alphabetical system based on the frequency of occurrence of letters in a typical body of written work. Some letters are entered by activation of a single key and others by activation of two or more different keys in sequence. Letters entered by activation of a single key require touching and un-touching of the same key, i.e. tapping. Letters entered by activation of two or more different keys require a sequence of touching, drag or slide, and un-touching actions.

According to one aspect of the invention, letters are assigned to each key in accordance with position elements of a position array, which include a central position, and a plurality of peripheral positions that point to an adjacent key within the array of keys. The most frequently occurring letters are assigned to the central positions of the keys and less frequently occurring letters to peripheral positions. Most frequently occurring letters are entered by activation of a correspondingly assigned key twice. Less frequently occurring letters are entered by first activating the key assigned to the less frequently occurring letter and then activating the key to which the position element of the less frequently occurring letter points to.

An advantage of the interface is that there are fewer selection buttons than a standard interface that has one letter per key. A disadvantage is that because letters are assigned directly to the keys themselves, and there is more than one letter assigned to each key, the interface is confusing to view and therefore difficult to quickly identify what keystrokes to execute in order to enter a given character.

### BRIEF SUMMARY

The present invention provides a method of identifying and selecting characters from among a plurality of characters.

In accordance with one example embodiment of the invention, a computer processor electronically enables display of a plurality of primary characters and a plurality of secondary characters within a first region on a touch-sensitive electronic screen. Each secondary character is positioned adjacent to a primary character and is associated with its adjacent primary character. In addition, the computer processor electronically enables display of a plurality of selection buttons within a second region on the screen. The arrangement of the primary characters and the selection buttons roughly correspond to one another, in that for each primary character in the arrangement of primary characters there is a correspondingly positioned selection button in the arrangement of selection buttons.

The computer processor electronically enables selection of a primary character by receiving input resulting from contact of the selection button that corresponds to the selected primary character. The computer processor electronically enables selection of a secondary character by receiving input resulting from contact of the selection button that corresponds to the selected secondary character's associated primary character, as well as by movement of a tool in contact with the screen in a direction that substantially matches the position of the selected secondary character relative to the selected secondary character's associated primary character.

In accordance with another example embodiment of the invention, the tool is a human finger.

In accordance with another example embodiment of the invention, the number of selection buttons is ten and the total number of primary characters and secondary characters is 26.

In accordance with another example embodiment of the invention, the ten selection buttons are arranged in two rows of five buttons each and the 26 primary and secondary characters are arranged in two rows of thirteen characters each.

In accordance with another example embodiment of the invention, the primary and secondary characters are arranged so there are two secondary characters between each primary character.

In accordance with another example embodiment of the invention, the computer processor displays the selected character on the display screen.

In accordance with another example embodiment of the invention, the computer processor electronically enables successive selection of characters and display of the successively selected characters on the display screen.

The present invention also discloses an electronic apparatus that includes (1) a case having a touch-sensitive electronic screen, (2) an arrangement of primary and secondary characters within a first region on the electronic screen, each secondary character positioned adjacent to an associated primary character, (3) an arrangement of selection buttons within a second region on the screen, each selection button positioned to correspond with the position of a primary character, where each selection button enables selection of a primary character by contact of the selection button and selection of a secondary character by contact of the selection button followed by movement of a tool in contact with the screen, and (4) a processor inside the case, the electronic screen and the selection buttons communicatively coupled to the processor.

In accordance with another example embodiment of the invention, the position of the selected secondary character relative to the selected character's associated primary character corresponds to the direction of the tool's movement.

In accordance with another example embodiment of the invention, the tool is a human finger.

In accordance with another example embodiment of the invention, the number of selection buttons is ten and the total number of primary characters and secondary characters is 26.

In accordance with another example embodiment of the invention, the ten selection buttons are arranged in two rows of five buttons each and the 26 primary and secondary characters are arranged in two rows of thirteen characters each.

In accordance with another example embodiment of the invention, the primary and secondary characters are arranged so there are two secondary characters between each primary character.

The present invention also discloses a computer readable storage medium having computer executable instructions that electronically enables (1) display of a plurality of primary characters and a plurality of secondary characters within a first region on a touch-sensitive electronic screen, each secondary character positioned adjacent to a primary character and associated with its adjacent primary character, (2) display of a plurality of selection buttons within a second region on the screen, the arrangement of the primary characters and the selection buttons roughly corresponding to one another, in that for each primary character in the arrangement of primary characters there is a correspondingly positioned selection button in the arrangement of selection buttons, (3) selection of a primary character by receiving input resulting from contact of the selection button that corresponds to the selected primary character, and (4) selection of a secondary character by receiving input resulting from contact of the selection button that corresponds to the selected secondary character's associated primary character, as well as by movement of a tool in contact with the screen in a direction that substantially matches the position of the selected secondary character relative to the selected secondary character's associated primary character.

In accordance with another example embodiment of the invention, the computer readable storage medium has computer executable instructions that electronically enables display of the selected character on the display screen.

In accordance with another example embodiment of the invention, the computer readable storage medium has computer executable instructions that electronically enable successive selection of characters and display of the successively selected characters on the display screen.

### BRIEF DESCRIPTION OF THE SEVERAL VIEWS OF THE DRAWINGS

FIGS. 1-8 illustrate electronic devices consistent with the prior art.

FIG. 9 illustrates a user interface in accordance with one example embodiment of the invention.

FIG. 10 illustrates a method in accordance with one example embodiment of the invention.

FIG. 11 illustrates a user interface in accordance with another example embodiment of the invention.

FIG. 12 illustrates a schematic drawing of an electronic device in accordance with one example embodiment of the invention.

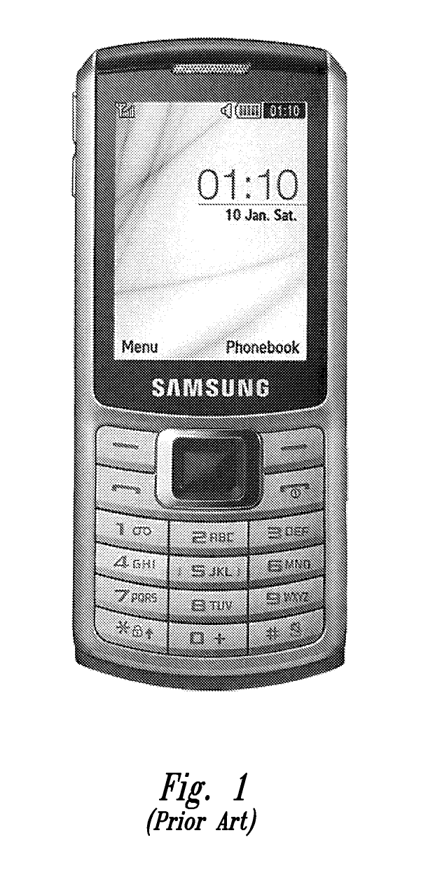

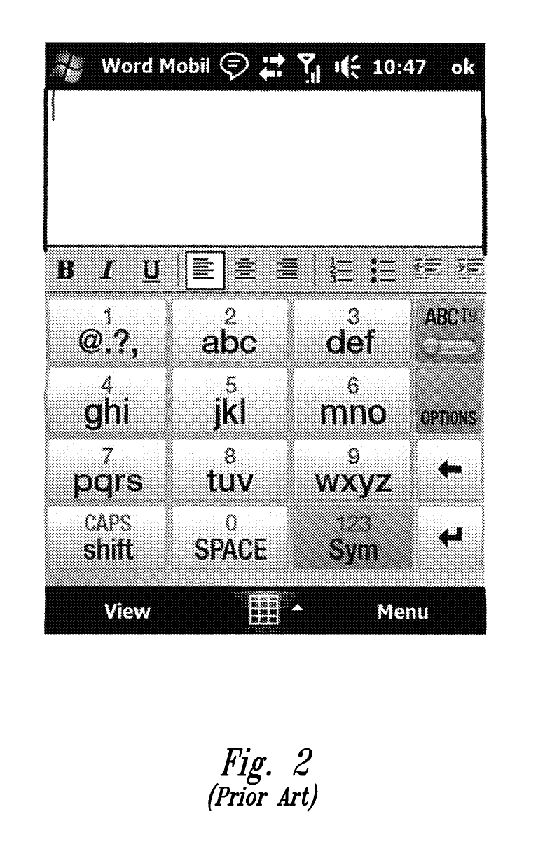

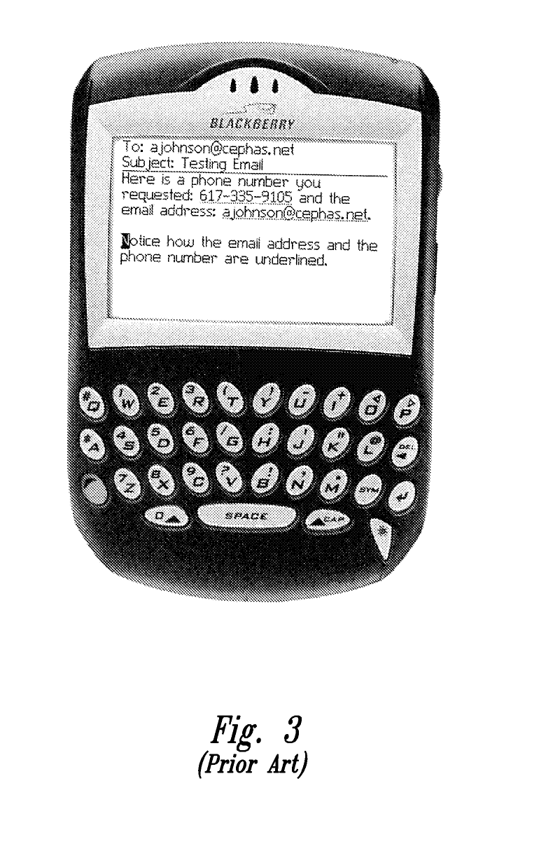

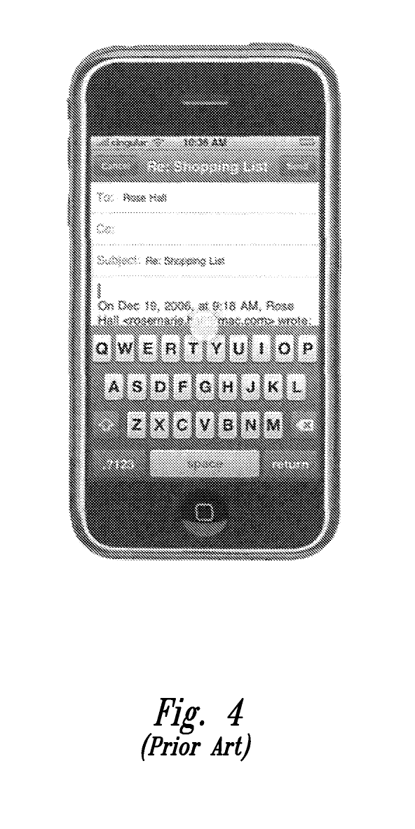

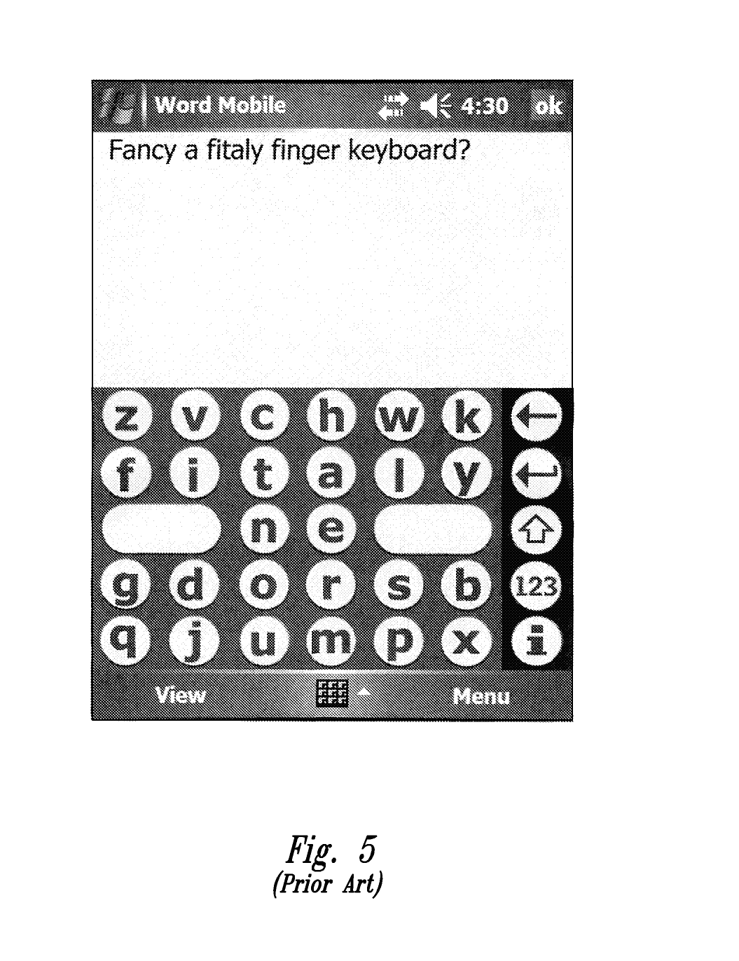

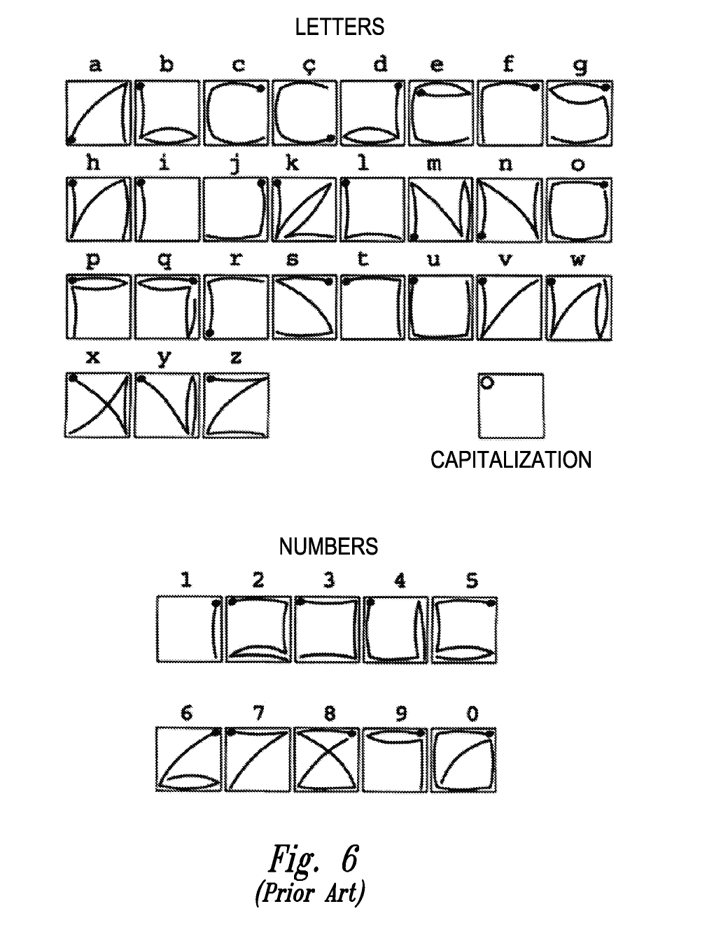

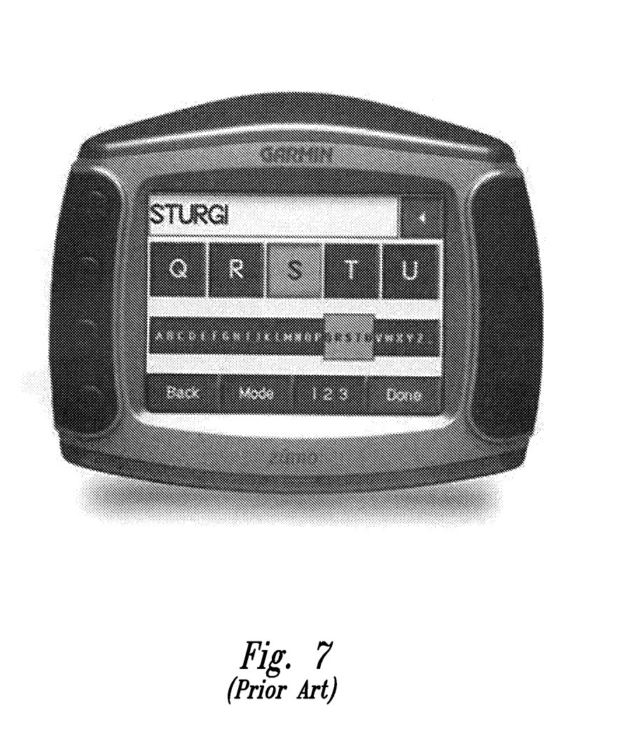

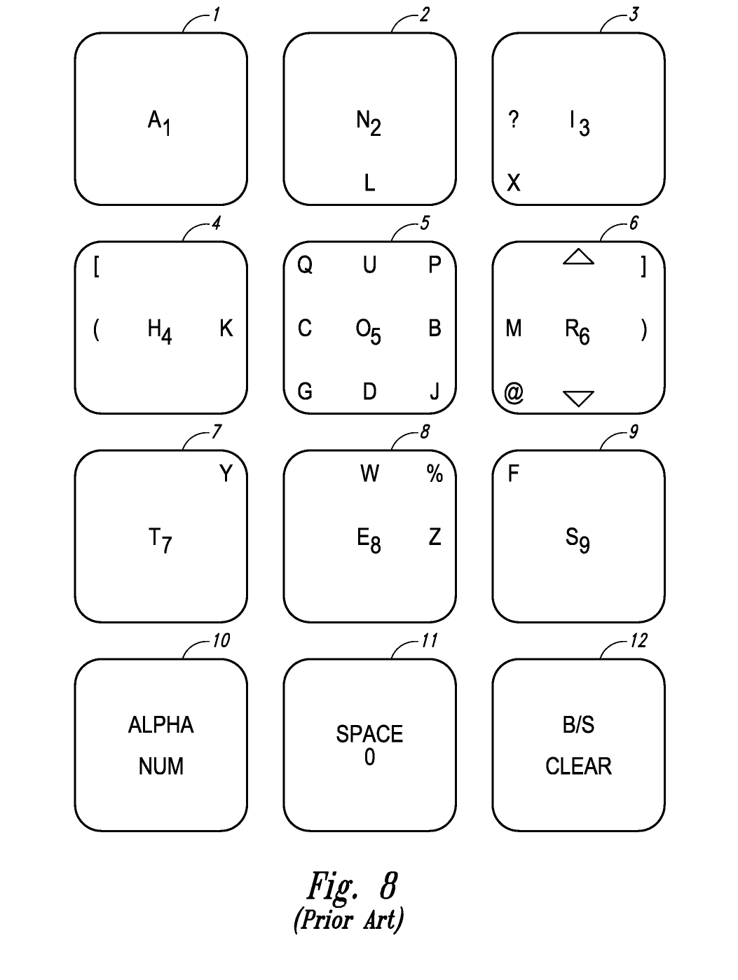

### DETAILED DESCRIPTION

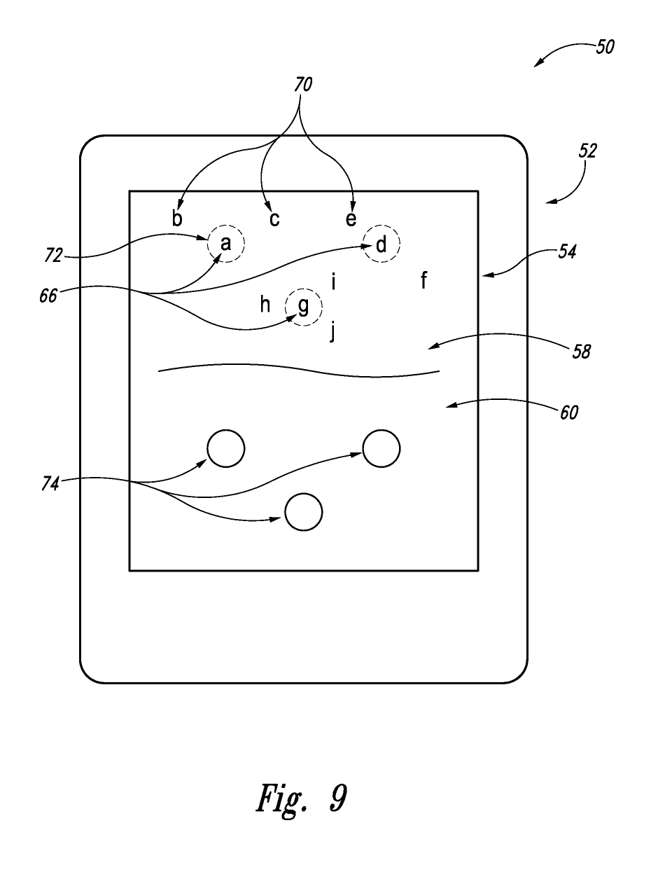

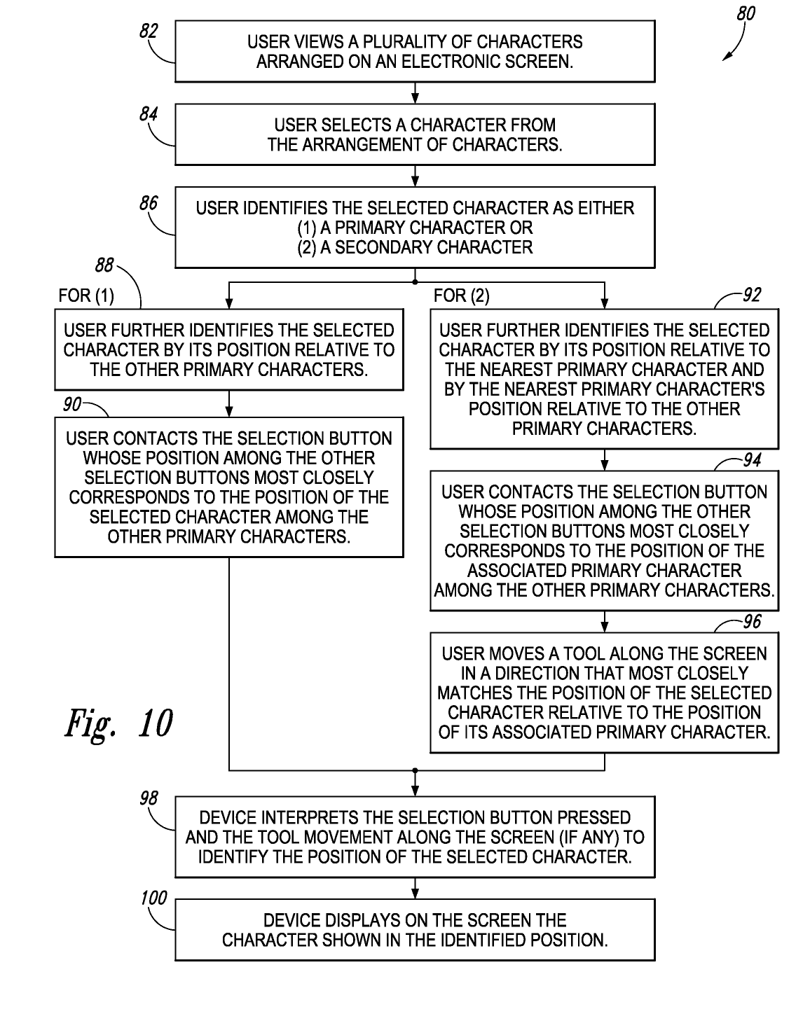

FIGS. 9 and 10 show, respectively, a user interface and a character specification method in accordance with one example embodiment of the invention.

The user interface 50 of FIG. 9 includes an electronic device 52 having a touch-sensitive electronic display screen 54 on one face. The display screen 54 may be any one of a variety of electronic display screens known in the industry and may include responsiveness to touch by either an inanimate tool or a human finger. The display screen 54 may be contained within a case.

The electronic display screen 54 includes a menu region 58 and a non-menu region 60. Distributed within the menu region 58 are a plurality of primary characters 66 and a plurality of secondary characters 70. Primary characters 66 are distinguished from secondary characters 70 by their position in the menu region 58 but may also be distinguished by their appearance, for example by size, font, color, background, a near by mark, or other differentiating means. Distributed within the non-menu region 60 is a plurality of selection buttons 74.

The arrangement of the primary characters 66 and the arrangement of the selection buttons 74 substantially correspond to one another on a position-by-position basis. In other words, each primary character occupies a relative position in the arrangement of primary characters 66 that is the same as the relative position of a corresponding selection button in the arrangement of selection buttons 74. Said yet another way, for each primary character 66 in the menu region 58, there is a correspondingly placed selection button 74 in the non-menu region 60.

By way of example, in the example embodiment of FIG. 9 the primary characters 66 are the English language characters ‘a’, ‘d’, and ‘g’. In this example embodiment the primary characters 66 are arranged in the menu region 58 in the pattern of a triangle with a tip pointing downward. Likewise, the selection buttons 74 are arranged in the non-menu region 60 in substantially the same pattern—that of a triangle with a tip pointing downward.

There are clearly numerous alternative arrangements for the primary characters 66 and the selection buttons 74. Possible alternative arrangements for these are disclosed in categories, as follows.

First, the number of primary characters 66 and the number of corresponding selection buttons 74 can be from two up to any finite number.

Second, the pattern in which the primary characters 66 and the selection buttons 74 are arranged can be any. The triangle disclosed in the example embodiment of FIG. 9 is just one possibility. The number of different patterns that could be conceived is nearly infinite and any specific pattern is considered within the scope of the invention.

Third, the number of selection buttons 74 may exceed the number of primary characters 66. In other words, selection buttons in addition to those that correspond to primary characters 66 may be included in the plurality of selection buttons 74. In such an example embodiment, only a portion of the overall number of selection buttons 74 would match the pattern of the primary characters 66.

Fourth, the arrangement of the primary characters 66 and the arrangement of the selection buttons 74 can be implemented on different scales. For example, in an example embodiment, the arrangement of selection buttons 74 is on a scale several times greater than the arrangement of primary characters 66. This allows the primary characters 66 to be reduced in size, which requires less screen space, while allowing the selection buttons 74 to be larger in size, which makes them easier to press accurately.

Fifth, the arrangement of the primary characters 66 and the arrangement of the selection buttons 74 can be scaled differently in different dimensions. For example, the arrangement of the primary characters 66 and selection buttons 74 can be on the same scale along a vertical dimension of the screen 54, but the selection buttons 74 can be scaled three times that of the primary characters 66 along a horizontal dimension of the screen 58. This could make the selection buttons 74 elongated compared with a 1:1 scale and therefore easier to press accurately.

As stated earlier, the menu region 58 also includes a plurality of secondary characters 70. The plurality of secondary characters 70 is arranged within the menu region such that each secondary character 70 is positioned adjacent to a primary character 66. For example, in the example embodiment of FIG. 10, the secondary characters ‘b’ and ‘c’ are positioned adjacent to the primary character ‘a’. In another example from the same embodiment, the secondary characters ‘h’, ‘i’, and ‘j’ are positioned adjacent to the primary character ‘g’.

Each secondary character is associated with only one primary character—the primary character that the given secondary character is adjacent to. Therefore in the example embodiment of FIG. 9, ‘b’ and ‘c’ are associated with ‘a’ and ‘h’, ‘i’, and ‘j’ are associated with ‘g’.

The distance a secondary character 70 lies from its adjacent primary character 66 can vary—both from primary character to primary character and among the secondary characters 70 associated with a given primary character 66. In an example of the first case, in the embodiment of FIG. 9, the secondary characters 70 adjacent to ‘a’ are farther from the secondary characters adjacent to ‘g’. In an example of the second case, also from the embodiment of FIG. 9, the secondary character ‘f’ is farther from its adjacent primary character ‘d’ than the secondary character ‘e’.

There may be any number of secondary characters 70 displayed around each primary character 66, including the possibility of no characters at all. Some primary characters 66 may have more or fewer secondary characters 66 around them than others. For example, in the example embodiment of FIG. 9, ‘a’ and ‘d’ have only two secondary characters surrounding them whereas ‘g’ has three.

Clearly if the number of secondary characters 70 around each primary character 66 can be different from primary character to primary character, then their arrangement can be too. But even when primary characters 70 have the same number of secondary characters 66 surrounding them, the arrangement of the secondary characters 70 can be different. For example, in the example embodiment of FIG. 9, the primary characters ‘a’ and ‘d.’ both have two secondary characters 70 adjacent to them. However, in the case of ‘a’ both secondary characters 70 are above the primary character 66, whereas in the case of ‘d’ one secondary character 70 is above the primary character 66 and the other secondary character 70 below it.

As described above, in addition to distinguishing between primary and secondary characters based on position, primary characters 66 and secondary characters 70 can also be differentiated based on visual attributes such as size, font, color, background, a nearby indicator mark, or other differentiating means. As an example, in the example embodiment of FIG. 9, each primary character is shown inside a dashed circle 72.

The plurality of primary characters 66 and plurality of secondary characters 70 may include letters from the English language or other languages, as well as numbers, punctuation marks, or any kind of symbol or grammatical representation.

FIG. 10 shows a method 80 for specifying one character from among a plurality of characters in accordance with the user interface 50 of FIG. 9.

In one step 82 of the method, a user views a plurality of primary characters 66 and secondary characters 70 arranged within a menu region 58 of an electronic display screen 54. In another step 84 of the method, the user chooses a character from the arrangement of primary and secondary characters to be selected.

In another step 86, the user identifies the selected character as either a primary character 66 or a secondary character 70. In one example embodiment the user makes this determination based on whether the character corresponds with a selection button in the arrangement of selection buttons 74. If the selected character is one that matches up position-by-position with one of the buttons in the pattern of selection buttons, then that character is a primary character 66. Otherwise it is a secondary character 70. In another example embodiment of the method, this determination is made based on a distinguishing feature between primary characters 66 and secondary characters 70 such as by characters' size, font, color, background, a nearby mark, or other differentiating means.

If the character is a primary character 66, in another step 88 of the method the user specifically identifies the selected character by its position relative to the other primary characters. In other words, the character is identified by its relative position within the pattern or arrangement of primary characters.

If the character is a primary character 66, in another step 90 of the method, the user contacts the selection button whose position among the other selection buttons 74 most closely corresponds to the position of the selected character among the other primary characters 66. As described above, the primary characters match up position-by-position with the selection buttons. In this step, the user contacts the selection button 74 in the non-menu region 60 that corresponds to the position of the selected character inside the menu region 58. As an example, considering the example embodiment of FIG. 9, if the selected character is ‘a’, its position in the arrangement of primary characters 66 is top left among the three primary characters. Therefore, according to this step 90, the user contacts the top left selection button among the three selection buttons 74 because its position among the selection buttons most closely corresponds to the position of ‘a’ among the primary characters 66.

If the character is a secondary character 70, in another step 92 of the method the user specifically identifies the selected character by its position relative to the nearest primary character 66 and by that primary character's position relative to the other primary characters 66. In other words, the user notes the primary character with which the selected character is associated—which in one example embodiment is the nearest or adjacent primary character—and also notes the direction that the selected character is positioned relative to its associated primary character. In an alternative embodiment, a secondary character may be associated with its primary character based on a common font, color, size, background, marking, or other indicating means. In another example embodiment, any given primary character and its associated secondary characters have a common background in order to indicate the association between these characters.

If the character is a secondary character 70, in another step 94 of the method the user contacts the selection button whose position among the other selection buttons most closely corresponds to the position of the primary character with which the selected secondary character is associated. This step 94 is similar to an earlier step 90 for the case of a selected character that is a primary character—the user contacts a selection button whose position among the other selection buttons most closely corresponds to the position of a character among the other primary characters—except in this case the character is the character with which the selected character is associated, rather than the selected character itself.

If the character is a secondary character, in another step 96 of the method the user slides the tip of a tool along the screen in a direction that most closely matches the position of the selected secondary character with respect to the position of its associated primary character. This step 96 combined with the previous step 94 fully specifies any secondary character—(1) the selection button contacted specifies which group of secondary characters the selected character comes from and (2) the direction of the tool movement specifies the specific character from that group.

In one example embodiment of the invention, the two previous steps 94, 96 are combined in a single operation by using the tool to both contact the selection button and execute the directional movement. In one example embodiment, the tool is the user's finger and the user uses the tip of their finger to contact the selection button and then carry out the directional movement to specify the selected character from the group.

In another step 98 of the method, the device 52 interprets the selection button contacted and the direction of the tool movement along the screen, if any, to identify the position of the selected character in the menu region 58 on the screen 54.

In another step 100, the device 52 displays on the screen 54 the character shown in the identified position of the menu region 58.

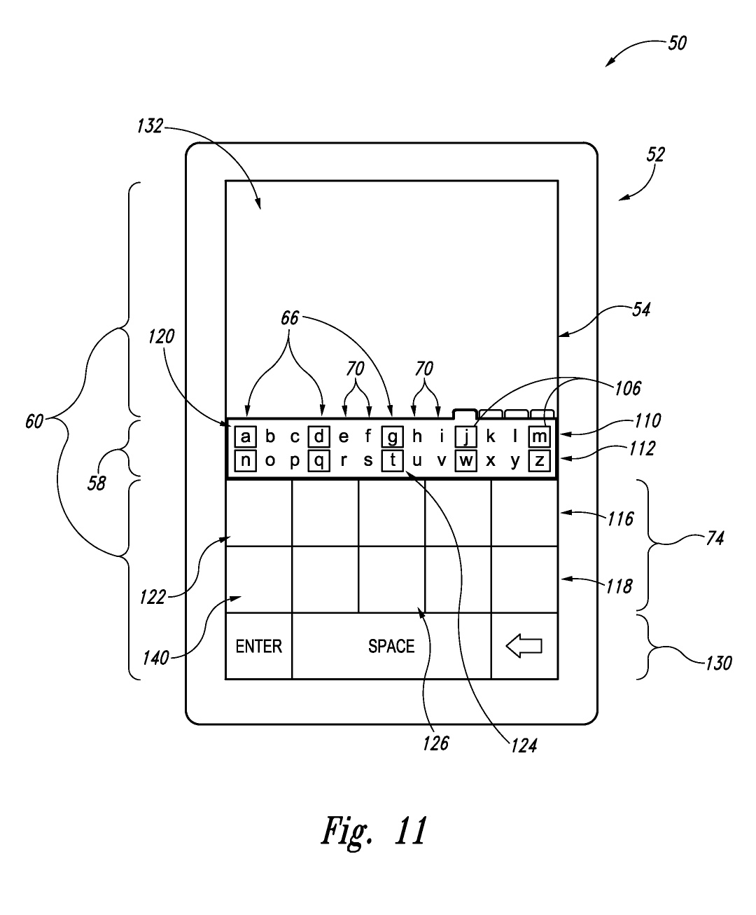

FIG. 11 shows a text entry interface 50 in accordance with another example embodiment of the invention.

The user interface 50 of FIG. 11 includes an electronic device 52 having a touch-sensitive electronic display screen 54 on one face. The display screen 54 may be any one of a variety of electronic display screens known in the industry and may include responsiveness to touch by either an inanimate tool or a human finger.

The electronic display screen 54 includes a menu region 58 and a non-menu region 60. Distributed within the menu region 58 are a plurality of primary characters 66 and a plurality of secondary characters 70. In this example embodiment, the primary characters 66 are distinguished from the secondary characters 70 by a square frame 106 that surrounds the primary characters 66. The secondary characters 70 have no feature surrounding them. In the example embodiment of FIG. 11 there are ten primary characters 66 in total; five primary characters 66 arranged within a first character row 110 and an additional five primary characters 66 arranged within a second character row 112.

Distributed within the non-menu region 60 is a plurality of selection buttons 74. In the example embodiment of FIG. 11 there are ten selection buttons 74 in total; five selection buttons 74 arranged in a first button row 116 and an additional five selection buttons 74 arranged in a second button row 118.

The arrangement of the primary characters 66 and the arrangement of the selection buttons 74 correspond to one another on a position-by-position basis. In the example embodiment of FIG. 11, each of the five primary characters in the first character row 110 occupies a position in the character row 110 that corresponds to the position of a selection button in the first button row 116. Said yet another way, for each primary character 66 in the first character row 110, there is a correspondingly placed selection button 74 in the first button row 116.

By way of example, in the example embodiment of FIG. 11, the left-most primary character in the first character row 120 is ‘a’. The selection button that corresponds to ‘a’ is the left-most selection button in the first button row 122. In another example from the example embodiment of FIG. 11, the middle primary character in the second character row 124 is ‘t’. The selection button that corresponds to ‘t’ is the middle selection button in the second button row 126. The same relationship exists between each of the ten primary characters 66 in each of the character rows 110, 112 and each of the ten selection buttons 74 in each of the button rows 116, 118.

As stated earlier, the menu region 58 also includes a plurality of secondary characters 70. The plurality of secondary characters 70 is arranged within the menu region such that each secondary character 70 is positioned adjacent to a primary character 66. In the example embodiment of FIG. 11, there are sixteen secondary characters 70. In the present example embodiment, the secondary characters 70 are arranged such that each secondary character is on one side or the other of their associated primary characters 66, that is, in the same row. For example, based on its proximity to ‘a’, the secondary character ‘b’ is associated with the primary character ‘a’. As another example, based on its proximity to ‘d’, the secondary character ‘c’ is associated with the primary character ‘d’. As another example, the secondary character ‘e’ is associated with the primary character ‘d’. This same relationship holds true for the other secondary characters of the first character row 110 and for all the secondary characters of the second character row 112. In an example from the second character row 112, the primary character ‘w’ has the secondary characters ‘v’ and ‘x’ associated with it.

In the example embodiment of FIG. 11, there are special function buttons 130 that appear in the non-menu region 58. The special function buttons 130 can trigger the device 52 to perform pre-programmed tasks, such as word processing functions. In the example embodiment of FIG. 11, there is also an output screen 132 that can display output from the device 52, such as characters selected by using the user interface 50, or to display text, images, or other symbols or representations stored in the device 52, downloaded from remote connections such as the internet or other devices, or derived from some other means.

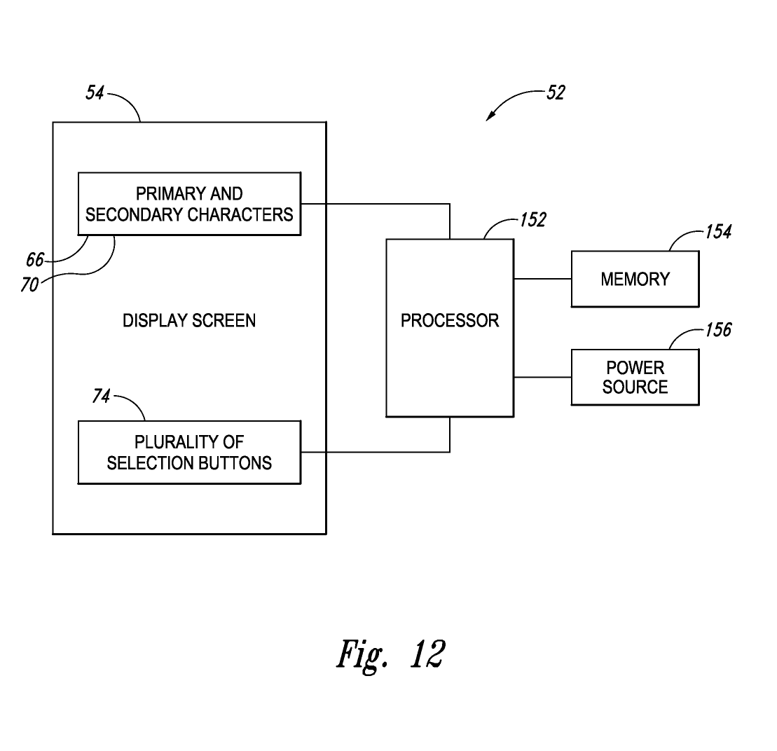

The user interface 50 of the example embodiment of FIG. 12 is operable according to the method of FIG. 10. In a first step, a user views the plurality of primary characters 66 and secondary characters 70 arranged in the menu region 58 of the screen 54. In another step, a user selects a character from the arrangement of primary characters 66 and secondary characters 70 desired for input. In another step, a user identifies the selected character as either a primary character or a secondary character. For the example user interface 50 embodied in FIG. 11, this determination is made based on whether the selected character has the square 106 surrounding it, or not. If the selected character has the square 106, then the character is a primary character.

In another step, if the selected character is a primary character, the user further identifies the selected character by its position relative to the other primary characters 66. For the example user interface 50 embodied in FIG. 11, this occurs by identifying whether the selected character is from the first character row 110 or the second character row 112 and by which of the five primary character positions the selected character occupies within that row. In another step of the method, the user contacts the selection button 74 whose position most closely corresponds to the row of the selected character and the position of the selected character in that row. In other words, the user contacts the selection button that comes from the button row (first or second) and the button position (of five possible positions) within that row that matches up position-by-position with the position of the selected primary character relative to the other primary characters.

In another step of the method, if the selected character is a secondary character, the user further identifies the selected character by (1) its position relative to its associated primary character and (2) by the associated primary character's position relative to the other primary character 66. For the example user interface 50 embodied in FIG. 11, this occurs by (1) identifying which direction along the row the selected character falls relative to its associated primary character, and (2) identifying whether the associated primary character is from the first character row 110 or the second character row 112 and by which of the five primary character positions the associated primary character occupies within that row.

In another step of the method, for the case where the selected character is a secondary character, the user contacts the selection button 74 whose position most closely corresponds to the row of the associated primary character and the position of the associated primary character in that row. This step is similar to the step in which the user contacts the selection button for the case of the selected character being a primary character, except in this case the selection button corresponds with the character with which the selected character is associated, rather than the selected character itself.

In a further step of the method for the case where the selected character is a secondary character, the user moves a tool along the screen 54 in the direction corresponding to the position of the selected secondary character relative to its associated primary character. For the example user interface 50 embodied in FIG. 11, this step involves sliding the tool along the row from the contacted selection button in the direction of the selected character relative to the selected character's associated primary character. In an example for the user interface 50 embodied in FIG. 11, to select ‘o’ the user contacts the left-most selection button 140 in the second button row 118 with a tool and then slides the tool, while it is still in contact with the screen 54, toward the right. In another example for the user interface 50 embodied in FIG. 11, to select ‘i’ the user contacts the selection button corresponding to the primary character ‘j’ with a tool and then slides the tool, while it is still in contact with the screen 54, toward the left.

Note that in one example embodiment the distance of the movement is not a determining factor in whether the primary character gets selected or the secondary character associated with that primary character gets selected. However, in an alternative embodiment, the distance of the movement can be a determining factor.

In one example embodiment both the length and direction of movement identify the associated secondary character. In still another example embodiment, the position of the tool when it is raised for the screen 54 identifies the selected character. For example, if the tool is still over the contacted selection button when it is picked up off the screen, then the primary character becomes selected. But in another example of this embodiment, if the tool has moved far enough to contact a different selection button than the one contacted at the start of the movement, then a secondary character is selected instead of the primary character once the tool is raised.

FIG. 12 shows an example schematic drawing of the electronic device 52 in accordance with one embodiment of the invention. The electronic device 52 includes the display screen 54, the primary characters 66, the secondary characters 70, the plurality of selection buttons 74, a computer processor 152, a memory 154, and a power source 156. The display screen 54, the memory 154, and the power source 156 are communicatively coupled to one another through at least the processor 152. The primary characters 66, the secondary characters 70, and the plurality of selection buttons 74 are positioned on the display screen 54 of the device 52. In one example embodiment, the elements 54, 66, 70, 74, 152, 154, 156 of the electronic device 52 shown in FIG. 12 cooperate to enable the method 80 disclosed in FIG. 10. In another example embodiment, the primary characters 66, the secondary characters 70, and the plurality of selection buttons 74 are arranged on the display screen 54 according to the user interface 50 of FIG. 9. In another example embodiment, the primary characters 66, the secondary characters 70, and the plurality of selection buttons 74 are arranged on the display screen 54 according to the user interface 50 of FIG. 11.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety.

Aspects of the embodiments can be modified, if necessary to employ concepts of the various patents, application and publications to provide yet further embodiments. These and other changes can be made to the embodiments in light of the above-detailed description.

The invention may be embodied as devices, systems, methods, and/or computer program products. Accordingly, some or all of the invention may be embodied in hardware and/or software, including firmware, resident software, micro-code, etc. The present invention may also take the form of a computer program product on a computer-usable or computer-readable storage medium having computer-usable or computer-readable program code embodied in the medium for use by or in connection with an instruction execution system. In the context of this application, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. By way of example, and not limitation, computer-readable media may comprise computer storage media and communication media.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer processor-implemented method comprising:
electronically enabling display of an arrangement of two or more primary characters within a first region on a touch-sensitive electronic screen;
electronically enabling display of four or more secondary characters within the first region, wherein each secondary character is positioned adjacent to a primary character and each primary character is associated with its one or more adjacent secondary characters;
electronically enabling display of two or more selection buttons within a second region on the screen in an arrangement wherein each selection button corresponds to a primary character having a relative position in the arrangement of primary characters which is the same as a relative position of the selection button in the arrangement of selection buttons;
electronically enabling selection of each primary character by receiving input resulting from contact of the corresponding selection button in the arrangement of selection buttons; and
electronically enabling selection of each secondary character by receiving input resulting from contact, by a tool, of a selection button in the arrangement of selection buttons whose corresponding primary character is associated with the secondary character, followed by movement of the tool along the screen in a direction substantially the same as that from the associated primary character to the secondary character.

2. The method of claim 1 wherein the tool is a human finger.

3. The method of claim 1 wherein the number of selection buttons is ten and the number of primary characters and secondary characters is 26.

4. The method of claim 3 wherein the ten selection buttons are arranged in two rows of five buttons each and the 26 primary and secondary characters are arranged in two rows of thirteen characters each.

5. The method of claim 4 wherein the primary and secondary characters are arranged so there are two secondary characters between each primary character.

6. The method of claim 1 further comprising displaying the selected character on the display screen.

7. The method of claim 6 further comprising electronically enabling successive selection of any of the six or more characters and display of the successively selected characters on the display screen.

8. An electronic apparatus comprising:
a case having a touch-sensitive electronic screen;
two or more primary characters positioned within a first region on the electronic screen;
four or more secondary characters positioned within the first region, each secondary character positioned adjacent to a primary character and associated with its adjacent primary character;
two or more selection buttons positioned within a second region on the screen, each positioned to correspond with a primary character, wherein each selection button enables selection of a primary character by contact of the selection button and each selection button enables selection of a secondary character by contact of the selection button followed by movement of a tool in contact with the screen; and
a processor inside the case, the electronic screen and the selection buttons communicatively coupled to the processor.

9. The electronic apparatus of claim 8 wherein the primary character selected is in a position that corresponds to the position of the contacted selection button.

10. The electronic apparatus of claim 8 wherein the secondary character selected is associated with the primary character that corresponds to the contacted selection button and is in a position relative to the associated primary character that substantially matches the direction of the tool's movement.

11. The electronic apparatus of claim 8 wherein the tool is a human finger.

12. The electronic apparatus of claim 11 wherein the number of selection buttons is ten and the total number of primary characters and secondary characters is 26.

13. The electronic apparatus of claim 12 wherein the ten selection buttons are arranged in two rows of five buttons each and the 26 primary and secondary characters are arranged in two rows of thirteen characters each.

14. The electronic apparatus of claim 13 wherein the primary and secondary characters are arranged so there are two secondary characters between each primary character.

15. A computer readable storage medium having computer executable instructions thereon for performing the following:
electronically enabling display of an arrangement of two or more primary characters within a first region on a touch-sensitive electronic screen;
electronically enabling display of four or more secondary characters within the first region, wherein each secondary character is positioned adjacent to a primary character and each primary character is associated with one or more adjacent secondary characters;
electronically enabling display of two or more selection buttons within a second region on the screen in an arrangement wherein each selection button corresponds to a primary character having a relative position in the arrangement of primary characters which is the same as a relative position of the selection button in the arrangement of selection buttons;
electronically enabling selection of each primary character by receiving input resulting from contact of the corresponding selection button in the arrangement of selection buttons; and
electronically enabling selection of each secondary character by receiving input resulting from contact, by a tool, of a selection button in the arrangement of selection buttons whose corresponding primary character is associated with the secondary character, followed by movement of the tool along the screen in a direction substantially the same as that from the associated primary character to the secondary character.

16. The computer readable storage medium of claim 15 further comprising displaying the selected character on the display screen.

17. The computer readable storage medium of claim 16 further comprising electronically enabling successive selection of any of the six or more characters and display of the successively selected characters on the display screen.
